(19) United States
(12) Patent Application Publication
(10) Pub. No.: US 2007/0274027 A1
(43) Pub. Date: Nov. 29, 2007

(54) Housing for High Performance Components

(75) Inventors: Harald Vetter, Heidenheim (DE); Ludwig Berg, Heidenheim (DE); Wilhelm Huebscher, Heldenfingen (DE)

Correspondence Address: SLATER & MATSIL, L.L.P., 17950 PRESTON RD, SUITE 1000, DALLAS, TX, 75252-5793, US

(73) Assignee: EPCOS AG, MUENCHEN (DE)

(21) Appl. No.: 10/591,483

(22) PCT Filed: Feb. 18, 2005
(86) PCT No.: PCT/DE05/00280

§ 371 Date: May 24, 2007

(30) Foreign Application Priority Data
Mar. 4, 2004 (DE) 10 2004 010 712.2

(51) Int. Cl. H02B 1/00

(52) U.S. Cl. 361/600

(57) ABSTRACT

A housing can be used for high-power components, especially high-power capacitors. A housing has a carrier platform made from a suitable electrically insulating material and a preferably metallic cover, wherein the thermal expansion coefficients of the platform and of the cover are matched to each other. This matching is achieved according to the invention by adjusting the glass-fiber coefficient of a fiber-composite material.

This application is a continuation of co-pending International Application No. PCT/DE2005/000280, filed Feb. 18, 2005, which designated the United States and was not published in English, and which is based on German Application No. 10 2004 010 712.2 filed Mar. 4, 2004, both of which applications are incorporated herein by reference.

### TECHNICAL FIELD

The invention relates to a housing for high-power components, especially power capacitors, which can be used, e.g., as DC-link capacitors in IGBT (Insulated Gate Bipolar Transistor) converters.

### BACKGROUND

For low-power IGBT converters, it is possible to use a single capacitor as a DC-link capacitor. The capacitor can be mounted directly on a stripline of the IGBT panel, e.g., by means of an attachment element (attachment bracket) at an angle of 90°. The attachment element guarantees a mechanical connection to the vibration-resistant capacitor and an electrical connection with the lowest possible inductance. An attachment element suitable for a low-inductive connection of the capacitor on the IGBT panel represents an essential cost component. The assembly expense is also high. In addition, several bypass capacitors are spatially distributed over the stripline of the IGBT panel and connected with low inductance in parallel with the DC-link capacitor. A low-inductance connection of a capacitor battery by means of ribbon cables is known, e.g., from the publications EP 0450122 A1 and DE 19816215.

For high-power IGBT converters, the DC-link capacitance function is designed so that the capacitors are combined into a somewhat low-inductance DC-link battery through a vibration-resistant metal frame and a stripline and are connected to the stripline of the IGBT panel. The vibration-resistant metal frame, the stripline for a low-inductance connection to the DC-link capacitor battery, as well as the connection elements between the capacitor battery and the IGBT panel are the essential cost components of this technical solution.

High-power components are usually exposed to a high temperature load, which comes about as a result of the transfer of high powers.

It is known to arrange high-power components on metal bodies which are used as cooling bodies and/or for grounding power components. The power components can be arranged and tightly closed in a steel sheet-metal housing. External contacts, which are brought into contact with the power components by means of electrical feedthrough sockets insulated from the housing, are available on the surface of the housing. The compact construction of the component, which includes a circuit made from several components, has the advantage that such a component can be easily installed in a power system (e.g., in a distributor box) or can be quickly replaced in the case of a failure.

It is known to arrange several components connected into a circuit in one plastic housing. However, the construction of a high-power block that can carry current in a plastic housing is not feasible, because most known plastics cannot withstand the high powers or do not satisfy the fire-protection standards that are to be maintained.

### SUMMARY OF THE INVENTION

The purpose of the present invention is to disclose an economical housing that is also suitable for high-power applications.

The invention is based on the idea of forming a housing in two parts with one metal and one plastic part. In this way, economical electrical feedthrough sockets can be integrated in the plastic part, where the metal part of the housing is used for grounding or heat dissipation. The construction of a two-part housing that is suitable for high-power applications with one metal and one plastic part was difficult until now, because metals and plastics, as a rule, exhibit significantly different thermal expansion coefficients, such that thermal loads at the interface between the metal and plastic produce relative movements of the material, which over the long term negatively affect the tightness of the connection point.

Therefore, with the invention a housing is provided, which has a carrier platform made from a suitable electrically insulated material and a preferably metallic cover, wherein the thermal expansion coefficients of the platform and the cover are adapted to each other.

It is desirable to adhere the insulating carrier platform tightly to the cover, which would guarantee a permanent tight adhesion between the two parts of the housing and a high mechanical strength at the connection point. These requirements can be satisfied economically, e.g., by a fiber-composite material, in particular a glass fiber-reinforced polyester. This fiber-composite material is a duroplastic, that is, a material that keeps its shape after its initial heating or cooling for further temperature loads.

A permanent tight adhesion of the carrier platform to the cover is guaranteed only when the thermal coefficients of longitudinal expansion of the two materials match each other to an adequate degree. The inventors recognized that the thermal expansion coefficient of a fiber-composite material can be changed or, in particular, reduced, by adding glass fibers. Matching the thermal coefficients of longitudinal expansion of the carrier platform and of the metal housing is solved according to the invention by preferably setting the material percentages of the composite material.

Other suitable reinforcing fibers can also be used instead of glass fibers.

A housing according to the invention for high-power components thus has a carrier platform made from fiber-composite material, which contains a certain percentage of reinforcing glass fibers, and at least one preferably metallic cover connected rigidly to the carrier platform. Here, the percentage of reinforcing-glass fibers in the fiber-composite material is set so that its thermal coefficient of longitudinal expansion matches that of the cover material, i.e., in terms of magnitude it deviates at a maximum by a value β relative to that of the cover. In different variants of the invention, β can equal 30%, 20%, or 10% according to the requirements of the application.

The fiber-composite material preferably contains a percentage of resin, e.g., polyester resin. The percentage of reinforcing-glass fibers preferably lies between 60 and 75%.

To match the coefficients of longitudinal expansion of the carrier platform, for example, to that of an aluminum cover with α=22 *10⁻⁶/K, the following polyester resin and reinforcing-glass percentages of the composite material are necessary: 35% resin and 65% reinforcing glass.

To match the thermal coefficients of longitudinal expansion of the carrier platform to that of a metal cover made from steel with α=13*10⁻⁶/K, the following percentages of polyester resin and reinforcing glass are necessary in the composite material: 30% resin and 70% reinforcing glass.

The cover is sealed with the carrier platform in at least one area, but preferably all over.

The cover preferably consists of a metal sheet, e.g., aluminum or steel or stainless steel. The cover can feature a coating made from an electrically insulating material.

A housing according to the invention has the advantage that the coefficients of longitudinal expansion of both parts of the housing can be matched to each other, so that the harmful relative movements of the housing parts at the connection interface during temperature fluctuations are prevented and therefore an extremely long-life sealing effect is guaranteed.

The carrier platform of the housing according to the invention has the advantage that it can be economically produced and in this way fulfills several functions, e.g., the mounting of the power components, the bottom-side closure of the cover and the provision of external contacts for corresponding power modules.

A module with a housing according to the invention is distinguished by low weight, high current-carrying capacity, and good assembly possibilities. The housing according to the invention guarantees a low selection rate of the modules.

The power module with a housing according to the invention is suitable for relatively large operating currents of the DC-link battery. Through a special modular construction (see below) and, in particular, through a parallel circuit of several low-inductance capacitors, a low self-inductance can be realized in the module per capacitor. In one variant, the module is mounted directly on the power rails, which additionally reduces the parasitic circuit inductance. Through the described measures, the circuit inductance is also reduced below a maximum permissible value without bypass capacitors.

The high-power components can be mounted by means of attachment elements onto the carrier platform or on the cover.

A module with a housing according to the invention can include, e.g., a capacitor block, which is encapsulated in the housing and which has at least one power capacitor, preferably one or more self-sealing housed or unhoused capacitor elements, wherein round, flat, and layered elements, but also oil-impregnated variants produced, in particular, with dry technologies, can be used. Several capacitor elements can be provided in a composite and here can preferably be connected in parallel to each other.

### BRIEF DESCRIPTION OF THE DRAWINGS

In the following the invention will be explained in more detail with reference to embodiments and the associated figures. The figures show different embodiments of the invention with reference to schematic, not-to-scale representations. Equivalent or equivalently functioning parts are designated with the same reference symbols. Shown are:

FIG. 1A, a perspective representation of a housing for high-power module according to the invention;

FIG. 1B, schematically a cross section through the housing according to the invention from FIG. 1A, perpendicular to the end side of the housing;

FIG. 1C, schematically a cross section through another housing according to the invention, perpendicular to the end side of the housing;

FIG. 2A, a schematic top view from below on the cover of the housing according to FIG. 1A;

FIG. 2B, a schematic top view on a side wall of the cover according to FIGS. 1A and 2A;

FIG. 2C, an enlargement of the detail X according to FIG. 2A;

FIG. 2D, schematically a cross section through the cover of the housing according to FIG. 2A, along section B-B;

FIG. 3, a schematic top view from above on the carrier platform;

FIG. 4A, section A-A through the carrier platform according to FIG. 3;

FIG. 4B, an enlargement of the detail Z according to FIG. 4A;

FIG. 4C, an example assembly of a high-power component with a housing according to the invention on external power rails;

FIG. 5A, section D-D through the carrier platform according to FIG. 3;

FIG. 5B, section E-E through the carrier platform according to FIG. 3, before the assembly of the cover on the carrier platform;

FIG. 5C, section E-E according to FIG. 3, after assembly of the cover on the carrier platform;

FIG. 6A, schematically in a power module according to the invention from FIGS. 6B, 6C, the connection of a power capacitor with external contacts of the module;

FIG. 6B, a schematic top view from below on the carrier platform of the power module;

FIG. 6C, a schematic view of the end side of the housing according to the invention with the carrier platform from FIG. 6B;

FIG. 7A, another example of the connection of a capacitor in a module according to the invention with two mounting planes;

FIG. 7B, a schematic view of the side wall of a module according to the invention from FIG. 7A;

FIG. 8A, an example connection sequence of the capacitor poles to the external contacts of a module according to the invention with six external contacts;

FIG. 8B, a schematic top view from below on the carrier platform of a module according to the invention with the connection of the external contacts according to FIG. 8A;

FIG. 8C, a schematic top view on a side wall of a module with the carrier platform from FIG. 8B;

FIG. 9A, an example connection sequence of the capacitor poles to the external contacts of a module according to the invention from FIG. 9B;

FIG. 9B, a schematic top view from below on the carrier platform of a capacitor module with eight external contacts;

FIG. 10A, an example connection sequence of the capacitor poles to the external contacts of a module according to the invention with two mounting planes from FIGS. 10B and 10C;

FIG. 10B, a schematic top view from below on the carrier platform of the module from FIG. 10C;

FIG. 10C, a schematic side view of the module with the carrier platform from FIG. 10B;

FIG. 11A, an example connection of two modules with housings according to the invention;

FIG. 11B, a schematic top view from below on the interconnected modules from FIG. 11A;

FIG. 11C, a schematic view of the end side of one of the modules from FIGS. 11A and 11B;

FIG. 12A, a schematic top view from below on the carrier platform of a module with external contacts in the form of a plug pin;

FIG. 12B, a schematic side view of the module with the carrier platform from FIG. 12A;

FIG. 12C, a schematic view of the end side of a module with the carrier platform from FIG. 12A; and

FIG. 12D, an enlargement of the detail Z from FIG. 12B.

The following list of reference symbols can be used in conjunction with the figures:
1 Carrier platform
1′, 1d Plastic platform
2 Cover
2d Jacket
8 Impregnating opening
10 Recess in the insert area of the carrier platform
18 First recess
18a Third recess in the carrier platform
18b Sealing compound
18c Attachment element (insert)
19 Second recess in the carrier platform for countersinking the threaded bolt 99
20 Hollow space
21 Attachment tab
22 Bore in the attachment tab
90 Power rail
90a Insulation of the power rail 90
91 Plug
92 External contact
92a Electrical connection of the high-power component
92b Attachment element (screw)
92c Contact spring
93 Opening
93a Support element
94 Insulating frame for holding the contact springs 92c
95 Sealing element
95a Compound
96 Plug housing
99 Attachment element (threaded bolt)
100 Attachment bracket
100a Bores
101 Attachment bracket
103 Attachment elements formed in the cover
104 Fifth recesses in the carrier platform
105 Contact element
106 Insulating dividing wall
107 Plug pin contact
107a Attachment element
108 Plug pin contact
108a Attachment element
109 Attachment area of the carrier platform, which lies opposite the bores 22 in the attachment tabs 21
110 Fourth recess in the carrier platform for receiving high-power components
111 Latching element
C Capacitor

### DETAILED DESCRIPTION OF ILLUSTRATIVE EMBODIMENTS

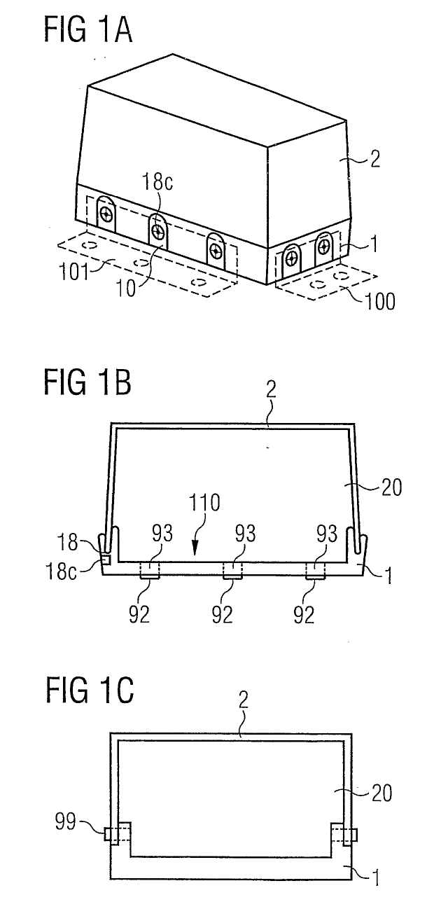

FIG. 1A shows a perspective view of a housing according to the invention with a carrier platform 1 and a cover 2. The carrier platform 1 is produced, e.g., in a pressing method from a fiber-composite material. Matching the thermal expansion coefficients of the carrier platform to that of the cover is achieved in that a corresponding percentage of reinforcing-glass fibers is provided in the material of the carrier platform.

In this variant of the invention, all of the necessary contact-forming elements (electrical feedthrough sockets) for electrical connection of the inside and outside of the corresponding module, as well as devices (inserts 18c) for receiving attachment elements, such as, e.g., attachment brackets, are integrated into the insulating carrier platform 1.

The side walls of the carrier platform 1 feature a shaped bevel apart from the limiting surroundings of the inserts, i.e., areas in which inserts 18c are installed. These areas represent recesses 10, whose base surface runs perpendicular to the base surface of the carrier platform 1. This shaping can be realized by a corresponding construction of the press mold. Through such a “rectangular” construction of the insert areas, it is possible to align the axis of the inserts 1 8c approximately parallel to the base surface of the carrier platform 1. Therefore, the rectangular shaping of the carrier platform in the insert area enables an optimum attachment of attachment elements 100, 101 (retaining brackets) indicated by dashed lines on the carrier platform. The retaining elements are connected on one side to the carrier platform and on the other side via indicated bores to a mechanically fixed frame, which is not shown here and which supports the retaining brackets from below in this example.

The inserts 18c represent metal sockets, which are suitable for receiving attachment elements, for example, threaded bolts or metal hooks. The inserts preferably have internal threads. The cover 2 is preferably made of metal. However, it is also possible to make the cover 2 from a metal sheet coated with plastic.

The inserts provide mechanically stable mounting points for various holder constructions. Through the rectangular shape of the insert areas according to the invention or through the above alignment of the insert axes, rectangular angled pieces, square tubes, brackets, but also bolts, etc., can be used as construction elements for attachment elements of the customers.

The inserts can be arranged on side surfaces of the carrier platform 1. Alternatively, it is also possible to form the inserts on the bottom side of the carrier platform.

FIG. 1B shows a schematic cross section through the housing according to the invention from FIG. 1A.

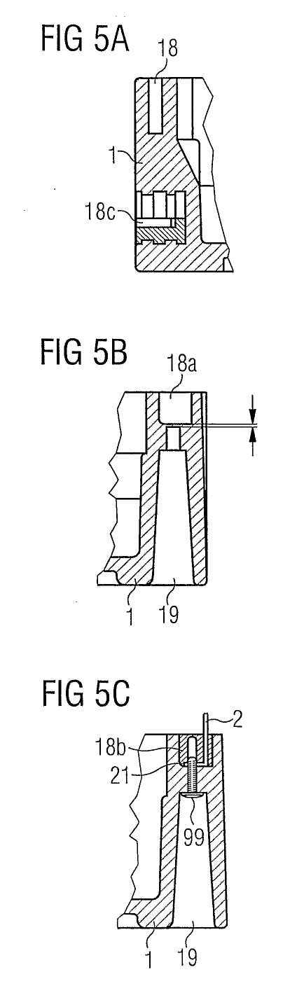

The carrier platform 1 and the cover 2 together form a preferably closed hollow space 20. In the carrier platform 1, a first recess 18 is formed, into which the cover 2 extends. In the carrier platform 1, there are also the second 19 and the third 1 8a recesses (not shown here) for receiving attachment elements, see FIG. 5B, and a fourth recess 110 for receiving power components (not shown here). In the carrier platform 1, there are openings 93, which are suitable, on one side, for forming contacts for the external contacts 92 of the corresponding module and, on the other side, for forming contacts for electrical connections of high-power components in the housing.

The first recess 18 is formed as a circular groove in the variant presented in FIG. 1B. However, it is also possible to form a shoulder for receiving the cover 2 in the side wall of the carrier platform 1 instead of a recess 18, see FIG. 1C. In FIG. 1C, the side wall of the cover 2 is connected rigidly to the outer wall of the carrier platform by means of an attachment element 99 (retaining screw, preferably a self-tapping screw). The cover 2 and the outer wall of the platform feature opposing openings for receiving attachment elements 99.

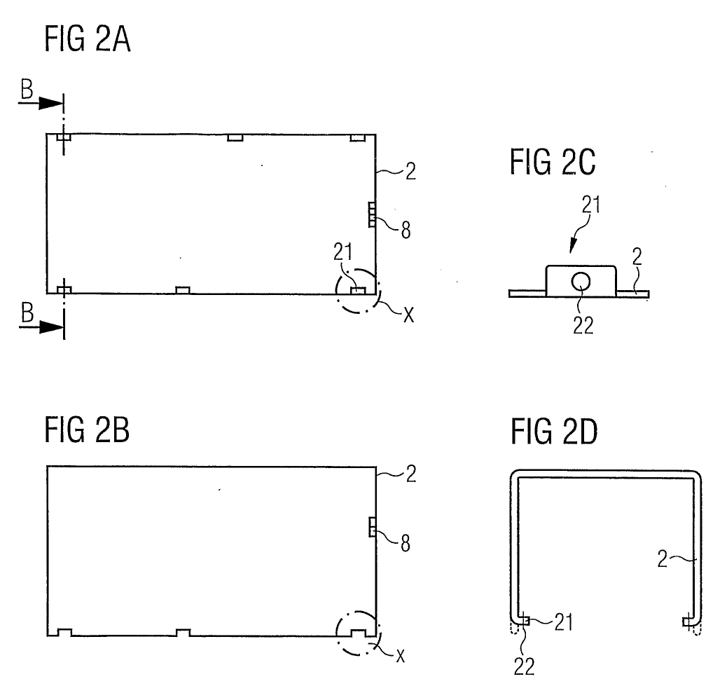

FIG. 2A shows a schematic top view from below on the cover 2 of a housing according to the invention. In the right side wall of the cover 2 (on the end side), an impregnating opening 8 is formed. It is possible to form more than only one impregnating opening in the housing cover. It is also possible to provide at least one opening or at least one attachment element in the housing cover for fixing high-power components under the cover.

The cover 2 has attachment tabs 21 each with a bore 22. The attachment tabs 21 of the cover are connected to the carrier platform 1 mechanically rigidly by a screw, see FIG. 5B.

In principle, for all of the attachment devices named in this publication, it is possible to replace the bores with an arbitrarily shaped opening.

The enlargement of the element X is shown in FIG. 2C. In the variant of the housing cover shown here, the attachment tabs 21 are angled inwardly. Alternatively, it is possible to angle the attachment tabs 21 outwardly.

FIG. 2B shows a schematic top view of the side of the housing cover presented in FIG. 2A, which connects the two end sides of the cover.

FIG. 2D shows a cross section through the cover according to section B-B in FIG. 2A.

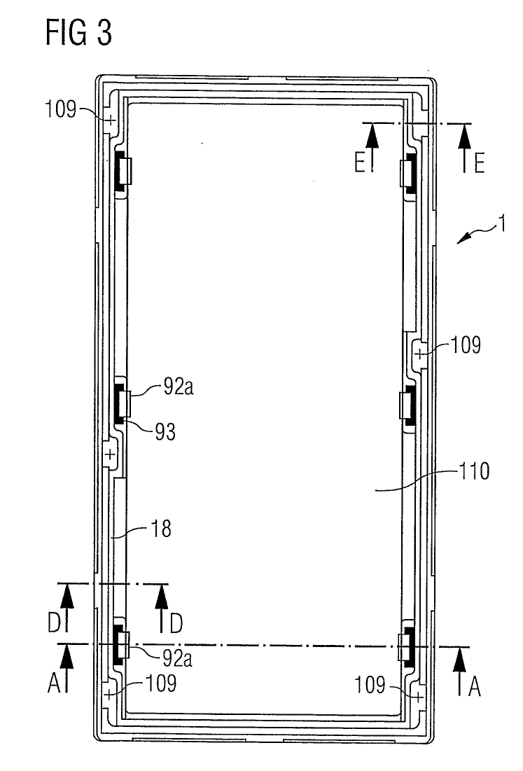

FIG. 3 shows a schematic top view from above on the carrier platform 1. In the center area of the carrier platform 1 there is a fourth recess 110 for receiving high-power components. In the side walls of the carrier platform 1 there are attachment areas 109, which lie opposite the bores 22 in the attachment tabs of the cover. In the openings 93, electrical connections 92a of a high-power component are visible, which are arranged in the fourth recess 110 of the carrier platform 1 and which are not shown in this figure.

The preferably circular first recess for the adhesion or sealing means 18b holds a sufficient amount of sealing compound (sealant) and, in connection with additional attachment measures (see FIG. 5C), provides for a permanent tight adhesion between the carrier platform 1 and the cover 2.

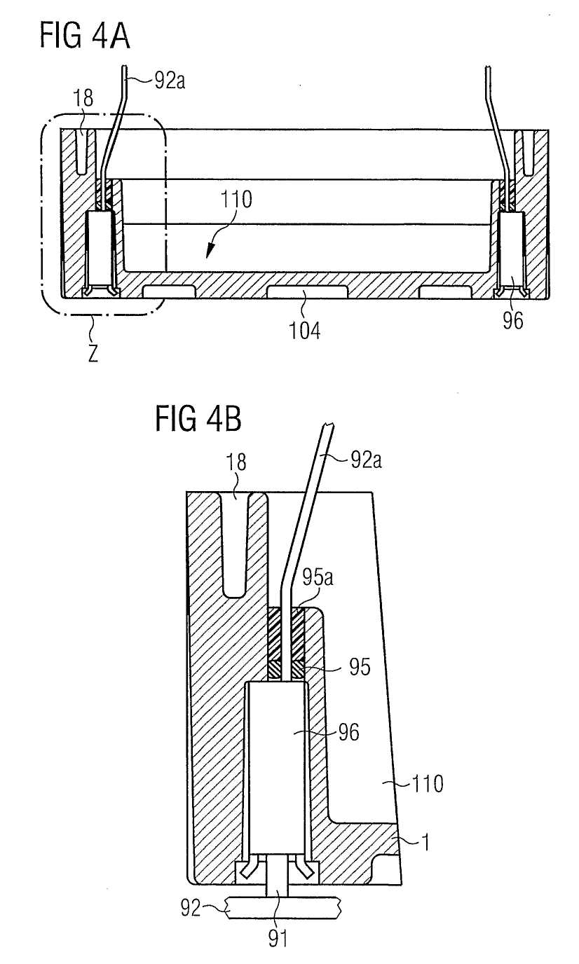

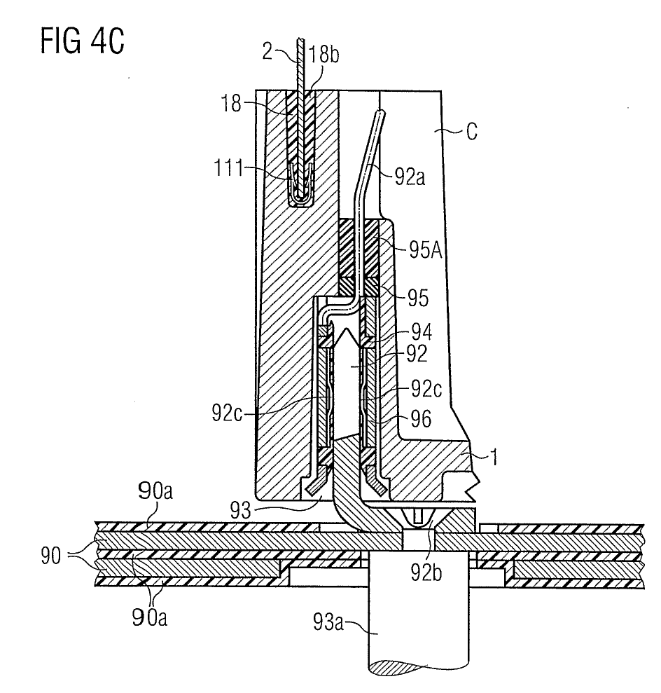

In FIG. 4A, section A-A of the carrier platform 1 according to FIG. 3 is shown. The base of the carrier platform 1 is structured on the bottom and features several fifth recesses 104. Such structuring of the platform is particularly successful in reducing the weight of the corresponding module and saving material in the carrier platform.

In FIG. 4B, the element Z according to FIG. 4A is shown enlarged. The electrical connection 92a is centered or fixed in the opening 93 of the carrier platform by means of an O-ring 95 and also mechanically fixed by a sealing compound 95a. The electrical connection 92a of the power component is electrically connected to the external contact 92 of the module via a metal sleeve (plug housing 96) and an electrical feedthrough socket (plug 91). The plug 91 can have a flat or round cross section.

Additional details for a feedthrough in a module according to the invention are seen in FIG. 4C. The electrical connection 92a forms a vibration-resistant contact with the external contact 92 by means of a metal sleeve 96 and a contact spring 92c. The part of the external contact 92 constructed here as a plug projecting into the opening 93 of the carrier platform is fixed in the opening 93 by a sleeve (insulating frame 94). There is an insulating frame 94, which is arranged in the plug housing 96, for holding the contact springs 92c. The plug housing 96 is widened at the bottom like a flange. The external dimensions of the insulating frame 94 and the plug housing 96 essentially match the shape of the opening 93.

The contact springs 92c ensure that the vibrations of the device on which the module is fixed are partially damped, which mechanically unloads the interface between the electrical connection 92a of the power component and the external contact 92 of the module, and thus guarantees the vibrational strength of the module.

Therefore, relative to a known DC-link capacitor battery, the capacitor module according to the invention has the advantage that the costs for a vibration-resistant metal frame and for the bypass capacitors can be eliminated, because the small circuit inductance required by the low-inductance construction of the capacitor module can also be realized without bypass capacitors.

The external contact 92 of the module is here angled or formed as “plug contact clip.” The bottom part of the external contact 92 is arranged on a power rail 90 and connected rigidly to the power rail 90 by an attachment element 92b. The external power rails 90 feature insulation 90a. The upper power rail 90 is arranged on a support element 93a, which, in addition to the power rails, represents an additional holding point for the electrical contact device 92, 92a, 92c, 96.

The electrical contact device 92, 92a, 92c, 96 is formed so that it is rigid against mechanical loads, such as, e.g., shocks/vibrations. However, it is unloaded from larger mechanical loads preferably by the attachment elements 100, 101 (see FIG. 1).

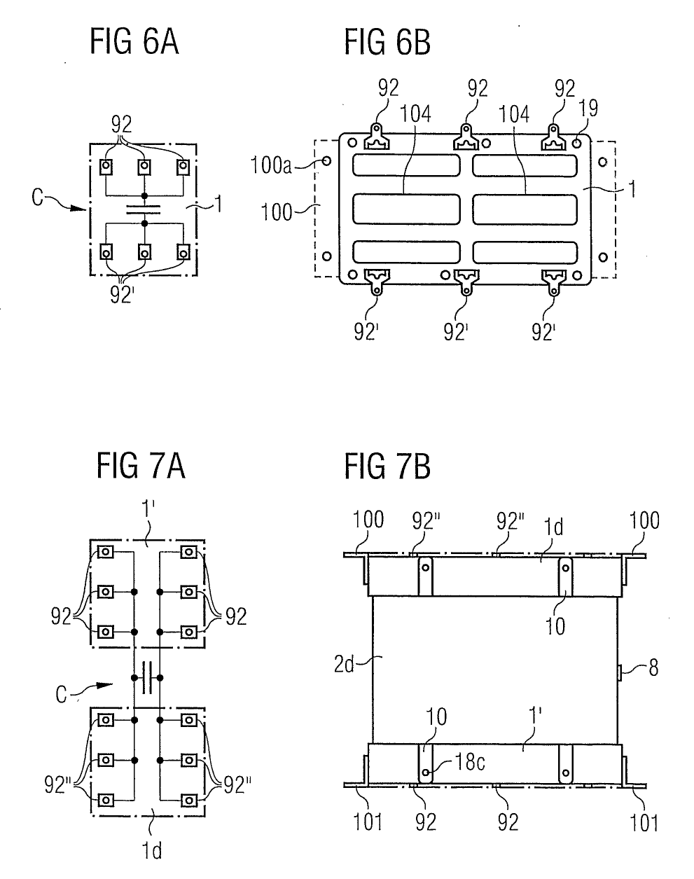

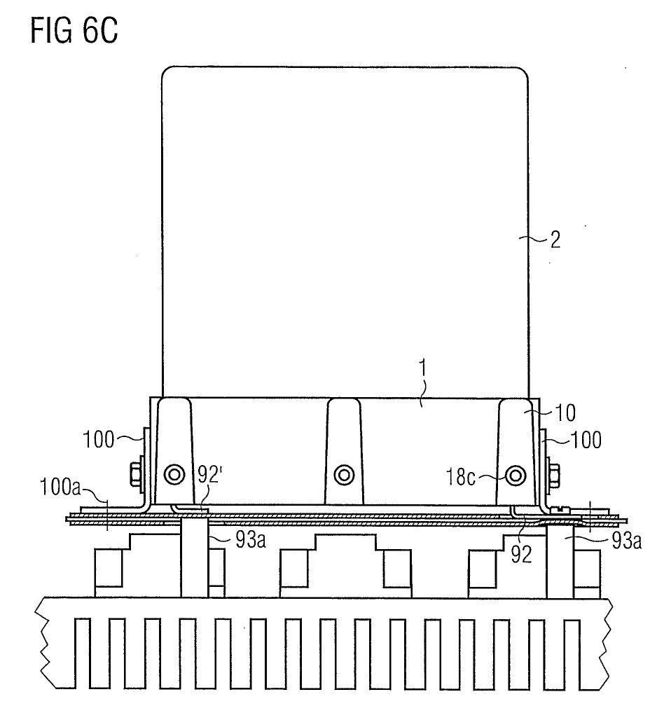

The external contact 92 is here bent on the bottom side of the carrier platform towards the center axis of the carrier platform. However, preferably the external contact 92 is bent, as indicated in FIG. 6B, so that it points away from the center axis of the carrier platform or is guided outwardly from the bottom side of the platform, so that its bores are exposed and accessible from above.

The cover 2 extends into the first recess 18. In the embodiment of the invention shown in FIG. 4C, the cover 2 is fixed or locked by a latching element in the first recess 18. The intermediate space between the side wall of the carrier platform 1 and the cover 2 is sealed with a sealing compound 18b.

FIG. 5A shows the section D-D according to FIG. 3. The insert 18c pressed into the carrier platform 1 preferably has internal threads, which can be connected, for example, by means of an attachment bolt, to an attachment bracket.

FIG. 5B shows section E-E of the carrier platform 1 according to FIG. 3 before assembly of the housing cover. The attachment tab 21 of the cover 2 is arranged in a third recess 18a of the carrier platform. A second recess 19 for countersinking an attachment element 99 is provided on the bottom side of the carrier platform 1. The third recess 18a can be formed as an expansion of the width of the first recess 18.

The second recess 19 is initially separated (see FIG. 5B) from the third recess 18a by a thin dividing wall, which is pierced during the assembly of the housing cover (see FIG. 5C) by a self-tapping screw or by the attachment element 99. This dividing wall seals the bottom side of the carrier platform against the possible leakage of sealing compound.

The attachment element 99, which connects the second recess 19 and the third recess 18a, is formed as a retaining screw or a self-tapping screw. It is guided into the carrier platform 1 via the second recess 19 and provides for the mechanical attachment of the cover 2 to the carrier platform 1.

The removal force of the attachment elements 99 is selected so that the internal pressure to be expected at the end of the service life of the capacitor can be established. This connection point between the carrier platform 1 and the cover 2 shown in FIG. 5C is used, in the case of a failure at the end of the service life of the capacitor, as a desired rupture point with a defined limit pressure.

The interface between the carrier platform 1 and the cover 2 can also be formed as a preferably circular adhesive connection according to FIG. 4C without retaining screws. This adhesive connection is then the desired rupture point with a defined limit pressure.

Another aspect of the invention relates to a low-inductance connection of a power module, especially a capacitor module. The power module features at least one power component, e.g., at least one capacitor or several capacitors, which are preferably connected in parallel and which are arranged in a housing with a carrier platform 1 and a cover 2.

In this variant of the invention, per capacitor pole there are at least two, preferably three or four, external contacts, which are simultaneously designed as attachment elements (e.g., clips, plugs, attachment bolts) or can be assembled by means of attachment elements preferably on the same power rail.

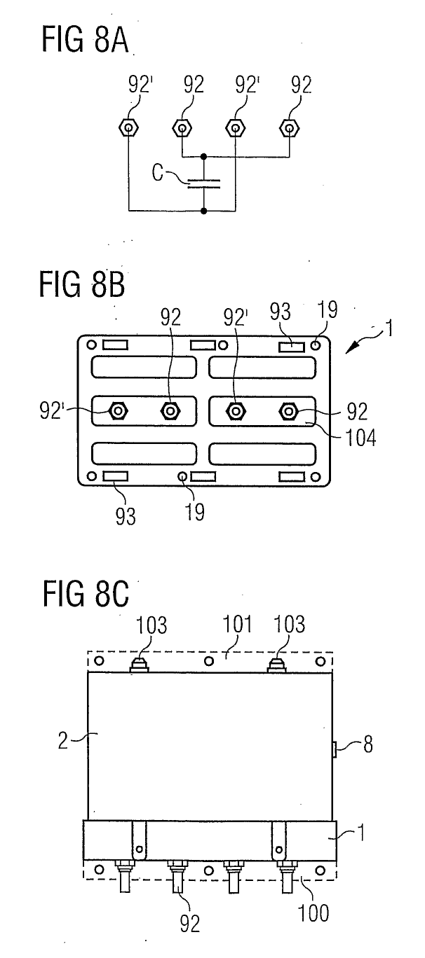

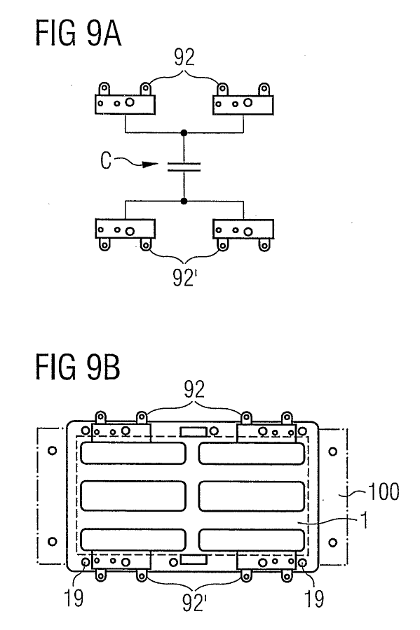

Preferably, external contacts of the module assigned to the same capacitor pole are arranged on the bottom side of the platform along an axis running parallel to the edge of the platform. The external contacts assigned to the various electrical poles are preferably arranged in two rows or along two axes parallel to each other (FIGS. 6B, 9B). However, all of the external contacts can also be arranged along a single axis, which is preferably arranged in the center on the bottom side of the platform (FIGS. 8B, 10B, 12A).

Each branch of an electrical connection distributed over several external contacts exhibits inductance, wherein the total inductance of the corresponding electrical connection is given from a parallel circuit of the individual inductances and is correspondingly lower than the inductance of a single external contact.

Through the distribution of an electrical connection onto several external contacts, in particular a low-inductance coupling of the capacitor module or the capacitor battery to the stripline of the IGBT panel can be improved. The DC-link capacitance realized as a module according to the invention in an IGBT converter is less expensive in comparison with known solutions, because the following cost components are eliminated: bypass capacitors, a metal frame as a carrier for the capacitor battery, a stripline for the low-inductance connection of the capacitors to a DC-link battery, a low-inductance supply line of the capacitor battery to the IGBT panel, and a part of the assembly costs. The construction of the module with a plug contact, see FIG. 4C, is especially advantageous. Here, the assembly costs are further reduced.

FIG. 6A shows an example low-inductance connection of a capacitor C in a housing according to the invention. According to the invention, a pole of the capacitor C is electrically connected to several connections 92 or 92′. The external connections 92 are constructed in the form of attachment tabs with bores.

In FIG. 6B, a schematic view of the module shown schematically in FIG. 6A from below is shown. On the base of the carrier platform there are several fifth recesses 104. In this way, the module becomes lighter and the material costs in the production of the carrier platform can be kept low.

An attachment bracket 100, which is connected to the inserts of the carrier platform 1 by attachment elements (not shown here), is mounted on the carrier platform 1. In the attachment bracket 100 there are bores 100a through which the component can be mounted, for example, in a steel sheet cabinet.

FIG. 6C shows a schematic side view on an end side of the module with the carrier platform according to FIG. 6B. The module is arranged on power rails of an IGBT module and fixed to these rails by means of the attachment elements 100. The external connections 92′ are here formed like external contacts according to FIG. 4C. The power rails with the capacitor module mounted on these rails are spaced apart from the cooling body of the IGBT module by means of insulating support elements 93a.

In FIGS. 7A and 7B there is another embodiment of a module according to the invention, which is suitable for mounting in two parallel mounting planes. The housing of the module has two preferably essentially identical plastic platforms 1′, 1d made from a fiber-composite material and a jacket 2d. The jacket 2d of the housing represents a square tube, which is closed on both sides by a plastic platform 1′, 1d.

The material of the jacket 2d is preferably metal, but can also be a plastic or a metal coated with plastic.

The external contacts 92 are arranged in a first (lower) mounting plane. The external contacts 92″ are arranged in a second (upper) mounting plane.

In FIG. 7A, the dashed lines indicate that the connections 92 are assigned to the first plastic platform 1′ and that the electrical connections 92″ are assigned to the second plastic platform 1d, respectively. The external contacts 92 are arranged in a first (lower) mounting plane. The external contacts 92″ are arranged in a second (upper) mounting plane. The two plastic platforms 1 and 1d are preferably essentially identical.

The external contacts 92 are formed in FIG. 6B as attachment tabs. However, it is also possible to form the external contacts in the form of clips, see FIG. 4C. Another possibility for forming the external contacts is presented in FIG. 8A. The external contacts 92 and 92′ are arranged along an axis and formed in the shape of screw connections. The external contacts 92 are here arranged in the recesses 104.

In FIG. 8C, the module according to FIGS. 8A and 8B is shown in schematic side view.

Attachment devices 103 are formed on the top side of the cover 2. The attachment devices 103 (e.g., weld bolts) can be fixed on the housing cover, for example, by welding. An attachment bracket 101 is mounted on the top side of the cover 2 by means of the attachment devices 103. Another attachment bracket 100 is connected to the carrier platform 1. The attachment brackets 100 and 101 are used for mounting the module, for example, in a steel sheet cabinet.

In this variant of the invention, the openings 93 are unused or blind.

The connection of a pole of a high-power component to several external contacts of the module has the advantage that this guarantees a low-inductance connection of the module to external circuits.

In FIGS. 9A and 9B, another advantageous low-inductance connection of a module to a high-power capacitor C and four external connections 92, 92′ is presented, wherein each external connection has a large surface area and is suitable for mounting on an external power rail by means of two screws.

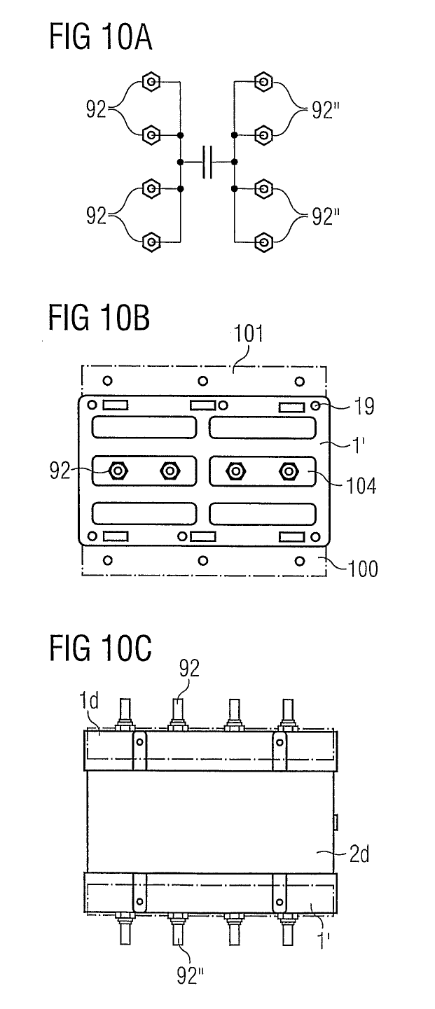

In FIGS. 10A to 10C, another module is presented that has external contacts 92 in the form of screw connections. The external contacts 92 are arranged in a first mounting plane and the external contacts 92″ are arranged in a second mounting plane. The external contacts 92 (or 92″) forming a contact with the appropriate capacitor connection are preferably arranged in the same mounting plane.

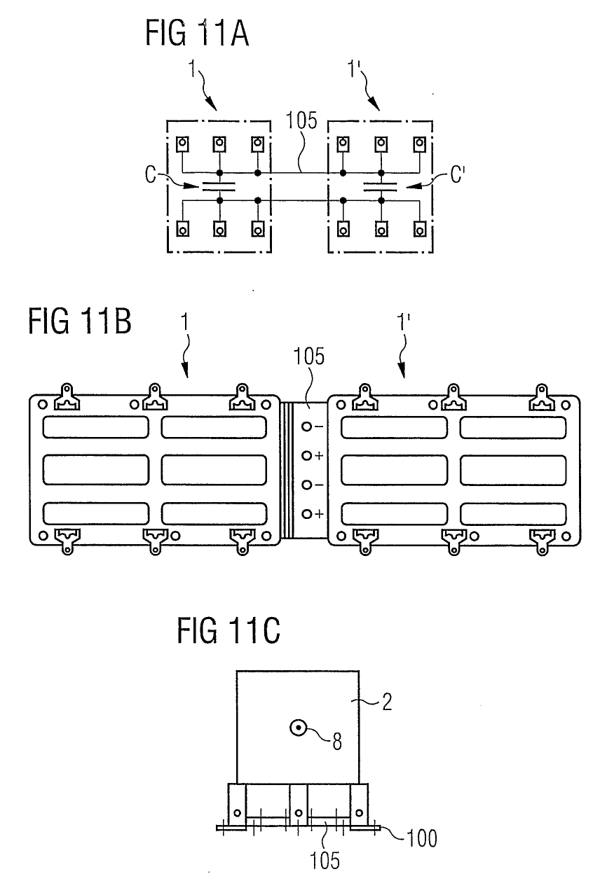

In FIGS. 11A to 11C, another advantageous module according to the invention is shown, which is connected to a similar module. The capacitor C is mounted on the carrier platform 1 of the first module. The capacitor C′ is arranged on the carrier platform 1′ of the second module. Each module features a contact element 105 arranged laterally on the carrier platform 1. The contact elements of both modules are turned towards each other and arranged so that their corresponding bores are arranged one above the other. The two contact elements 105 are connected to each other by means of attachment bolts.

The contact element 105 is a stripline with ± connections through which the capacitors C and C′ are connected in parallel with low inductance. Such a connection of the capacitor modules has the advantage that the component of an electrical connection between modules is integrated in each module and therefore an external power line can be eliminated at the interface between the modules. Such a capacitor battery is especially suitable for use at the interface to an IGBT converter and represents an economical solution for a vibration-resistant DC-link capacitor.

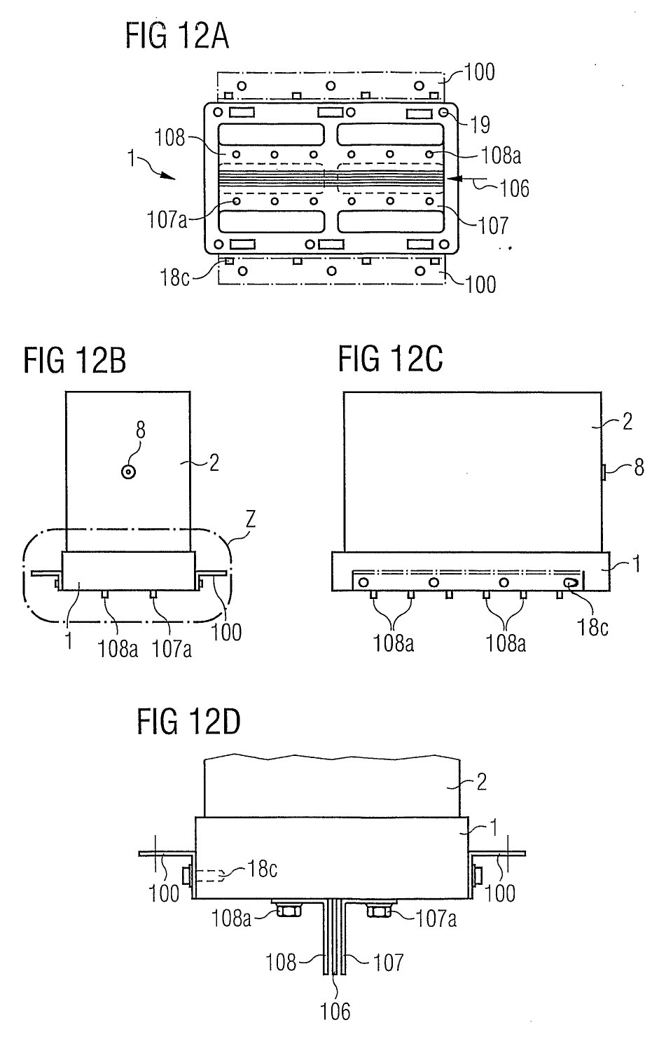

In FIGS. 12A to 12D, another embodiment of the invention is shown. Here, the external contacts of the module are formed in the shape of a so-called plug pin. This method of forming contacts is especially distinguished by low self-inductance and simultaneously high current-carrying capacity.

The plug pin has plug pin contacts 107 and 108, which are each formed as an angled element featuring openings for receiving attachment elements 107a and 108a. The plug pin contacts 107 and 108 are mounted on the carrier platform 1 by means of the attachment elements 107a and 108a.

The capacitor connections, which are not visible here, form a contact with a connection 107 or 108 of the plug pin via six threaded bolts per pole. A dividing wall 106 made from an electrically insulating material is arranged between the two plug pin contacts 107 and 108. The module can be mounted by means of the attachment bracket 100 on an external stripline.

The invention has been explained on the basis of only a few embodiments, but is not limited to these.

All aspects and features of the invention can be combined arbitrarily with each other and also with other known measures, e.g., for mounting the components or for constructing feedthrough sockets and contact elements.

For modules with a high nominal voltage, the housing cover 2 or the sheathing 2d according to FIG. 7B can consist of plastic.

In the housing, three-phase chokes can be arranged as high-power components.

In the cover 2, preferably in at least one cover wall, at least one opening for mounting high-power components can be provided.

1. A housing for electrical high-power-components, the housing comprising:
a carrier platform made from a fiber-composite material containing a reinforcing glass fiber component; and
at least one cover connected rigidly to the carrier platform,
wherein the reinforcing glass fiber component in the fiber-composite material is selected so that its thermal coefficient of longitudinal expansion deviates, in terms of magnitude, by a maximum of 30% from that of a material of the at least one cover.

2. The housing according to claim 1, in which the thermal coefficient of longitudinal expansion of the fiber-composite material deviates, in terms of magnitude, by a maximum of 20% from that of the material of the at least one cover.

3. The housing according to claim 1, in which the thermal coefficient of longitudinal expansion of the fiber-composite material deviates, in terms of magnitude, by a maximum of 10% from that of the material of the at least one cover.

4. The housing according to claim 1, in which a weight percent of reinforcing glass fibers lies between 50% and 90%.

5. The housing according to claim 4, in which the reinforcing glass fiber component lies between 60% and 75% of the fiber-composite material.

6. The housing according to claim 1, wherein the at least one cover comprises metal.

7. The housing according to claim 1, wherein the the at least one cover seals with the carrier platform in at least one area.

8. The housing according to claim 1, in which the at least one cover extends into a first recess.

9. The housing according to claim 1, further comprising attachment tabs, each attachment tab featuring at least one bore formed on a side of the carrier platform, wherein the carrier platform has openings, and wherein attachment elements connect the openings of the carrier platform to the corresponding at least one bore of the attachment tabs.

10. The housing according to claim 1, further comprising at least one recess for holding high-power components in the carrier platform.

11. The housing according to claim 1, in which inserts in the form of sockets for holding attachment elements are installed in at least one side wall of the carrier platform, wherein the axes of the sockets run parallel to the base of the carrier platform and wherein the side wall of the carrier platform runs perpendicular to its base in an area of the sockets.

12. The housing according to claim 1, in which openings for holding electrical feedthrough sockets between inside and outside of the housing are formed in the carrier platform.

13. The housing according to claim 1, further comprising a recess for holding high-power components provided in a center area of the carrier platform.

14. The housing according to claim 1, in which at least one opening for attaching high-power components is provided in at least one cover wall.

15. The housing according to claim 1, in which at least one impregnating opening is provided in a side wall or end wall of the cover.

16. A housing for high-power components, the housing comprising:
two parallel mounting planes, containing two plastic platforms, which correspond to the mounting planes and which are made from a fiber-composite material and a jacket arranged between the plastic platforms and connected rigidly to these platforms,
wherein openings for holding electrical feedthrough sockets are formed in each plastic platform, and
wherein a reinforcing glass fiber component in each plastic platform is set so that its coefficient of longitudinal expansion of the plastic platform deviates, in terms of magnitude, by β<30% of that of a cover.

17. A module with a housing according to claim 16, further comprising capacitors mounted in the housing.

18. The module according to claim 17, in which three-phase chokes are mounted in the housing.

19. The module according to claim 17, in which the openings are designed for holding electrical feedthrough sockets for ribbon cables.

20. The module according to claim 17, in which external contacts are provided in the form of plug clips, attachment tabs, a plug pin, or threaded bolt.

21. The module according to claim 17, in which an electrical connection of each capacitor forms a contact with several external contacts of the housing.
